(19) United States
(12) Patent Application Publication
(10) Pub. No.: US 2025/0258544 A1
(43) Pub. Date: Aug. 14, 2025

(54) VIRTUAL AGENT FOR PSYCHEDELIC-ASSISTED VIRTUAL REALITY MEDITATION

(71) Applicant: TRIPP, Inc., Los Angeles, CA (US)

(72) Inventors: Nanea Reeves, Sherman Oaks, CA (US); David Schwarz, Morrisville, NC (US); David Prampin, Los Angeles, CA (US); Sundee Strasburg, Salt Lake City, UT (US); Peter Kennedy, Los Angeles, CA (US); Colin Davies, Walnut Creek, CA (US); Justin Patrick Taber, Shelton, WA (US)

(21) Appl. No.: 18/438,284

(22) Filed: Feb. 9, 2024

(51) Int. Cl. G06F 3/01

(52) U.S. Cl. CPC G06F 3/015

(57) ABSTRACT

A virtual reality application adaptively generates a virtual reality experience intended to improve a user's mood. The VR application initializes a virtual reality experience including a virtual agent. The VR application prompts the user to consume a psychedelic compound. In a first time period, the VR application receives a first set of signals indicating a state of the user. The VR application detects a user mood based on the set of signals. The VR application determines that the user mood is different than a target mood. The VR application modifies one or more characteristics of the virtual agent to shift the user mood to the target mood. The VR application can implement a feedback loop to evaluate efficacy of the personalization modification(s) in shifting the user's mood to the target mood. Based on the efficacy, the VR application may implement additional modification(s).

### BACKGROUND

### Technical Field

This disclosure relates generally to a media content system, and more specifically, to a media device that intelligently provides a virtual reality experience tailored to improve a mood of a particular user.

### Description of the Related Art

Conventional media content systems are typically capable of providing static content such as movies or interactive content (such as video games) that may respond to actively controlled inputs provided by a user. For applications such as virtual reality guided meditation, relaxation, or other mood improvement applications, such traditional content has limited effectiveness because it is not sufficiently tailored to a particular user's characteristics or mood state. However, a technical challenge exists in predicting how a user's mood will change based on particular content. Moreover, this challenge is further complicated when performing psychedelic-assisted meditation therapy.

### SUMMARY

A virtual reality application adaptively generates a virtual reality experience intended to improve a user's mood. The VR application initializes a virtual reality experience including a virtual agent. The VR application prompts the user to consume a psychedelic compound. In a first time period, the VR application receives a first set of signals indicating a state of the user. The VR application detects a user mood based on the set of signals. The VR application determines that the user mood is different than a target mood. The VR application modifies one or more characteristics of the virtual agent to shift the user mood to the target mood. The VR application can implement a feedback loop to evaluate efficacy of the personalization modification(s) in shifting the user's mood to the target mood. Based on the efficacy, the VR application may implement additional modification(s).

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 illustrates a media system, according to one or more embodiments.

FIG. 2 is a block diagram of a media processing device, according to one or more embodiments.

FIG. 3 is a block diagram of a media server, according to one or more embodiments.

FIG. 4A illustrates a flowchart of presentation of a personalized virtual reality meditative experience, according to one or more embodiments.

FIG. 4B illustrates a flowchart of a feedback loop in the presentation of the personalized virtual reality meditative experience, according to one or more embodiments.

FIG. 5 illustrates an example virtual reality experience including a virtual agent, according to one or more example implementations.

### DETAILED DESCRIPTION

### Overview

A virtual reality application adaptively generates a virtual reality meditative experience intended to improve a user's mood. The virtual reality meditative experience may include virtual reality content, augmented reality content, mixed reality content, or some combination thereof. In general, the virtual reality meditative experience includes some amount of virtual content that is presented to the user. Example virtual content may include virtually-generated visual content, audio content, haptic content, or some combination thereof. The virtual reality experience may be presented to a user on a headset device. The headset device may include a display device for presenting virtually-generated visual content and/or and audio device for presenting audio content. The headset device may also include one or more input devices configured to receive inputs from the user or from a surrounding environment.

The virtual reality application presents a personalized virtual reality meditative experience that includes a virtual agent for guided meditation. The virtual agent may be an interactive character in the virtual reality meditative experience. The virtual agent may include a visual appearance and a vocal track. The visual appearance may be defined by a set of characteristics, and the vocal track may be defined by a set of characteristics. During presentation of the virtual reality meditative experience, the virtual reality application may modify the virtual agent to induce a mood shift in the user. The virtual reality application may receive a set of signals indicating a state of the user, e.g., a physical state, a mental state, an emotional state, a medicated state, a spiritual state, or some combination thereof. The virtual reality application may determine the user's mood based on the received set of signals. If the user's mood does not match a target mood to be achieved, the virtual reality application may modify the virtual agent and/or the virtual reality experience to shift the user's mood towards the target mood. In some embodiments, the virtual reality application may maintain a user profile that tracks responses of the user to the various modifications to the virtual agent and/or the virtual reality experience.

In one or more embodiments, the virtual reality meditative experience may be psychedelic-assisted. In such embodiments, the virtual reality application may prompt a user to consume a psychedelic compound. The virtual reality application may track the user's response to the psychedelic-assisted virtual reality meditative experience. In some embodiments, the virtual reality application may perform various analyses across a population of users in response to psychedelic-assisted virtual reality meditative experiences. The virtual reality application may build predictive models based on the analyses to refine content in the virtual reality meditative experiences, e.g., tailored for each type of psychedelic compound, or for various subpopulations of users that may respond similarly.

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Media System

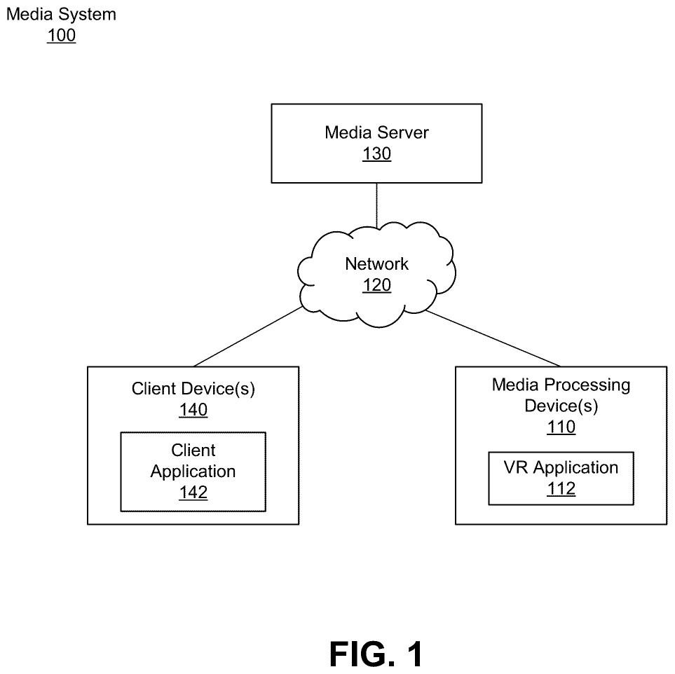

FIG. 1 is a block diagram of a media system 100, according to one or more embodiments. The media system 100 includes a network 120, a media server 130, one or more media processing devices 110 executing a virtual reality (VR) application 112, and one or more client devices 140 executing a client application 142. In alternative configurations, different and/or additional components may be included in the media content system 100.

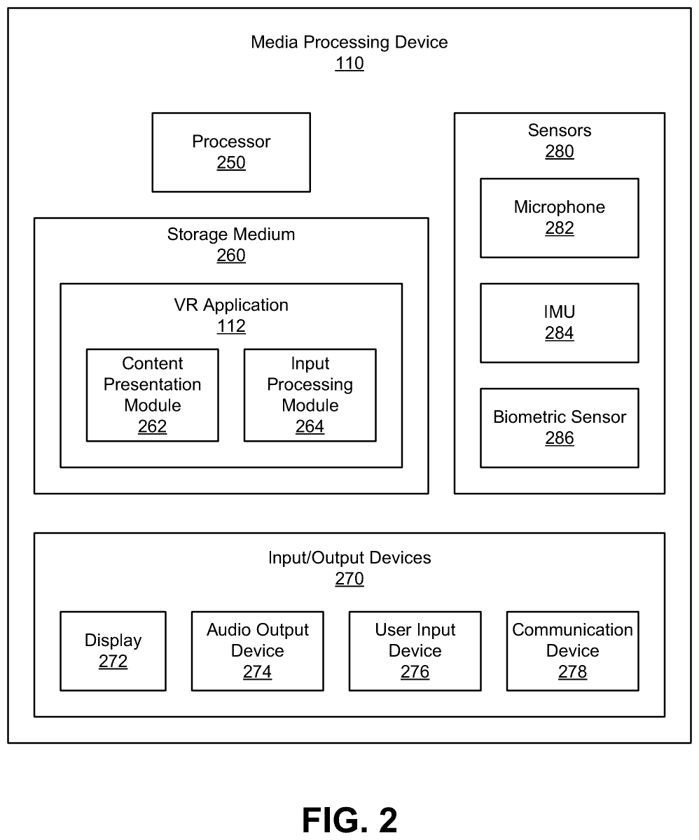

The media processing device 110 comprises a computer device for processing and presenting media content such as audio, images, video, or a combination thereof. In an embodiment, the media processing device 110 is a head-mounted VR device. The media processing device 110 may detect various inputs including voluntary user inputs (e.g., input via a controller, voice command, body movement, or other convention control mechanism) and various biometric inputs (e.g., breathing patterns, heart rate, etc.). The media processing device 110 may execute a VR application 112 that provides an immersive VR experience to the user, which may include visual and audio media content. The VR application 112 may control presentation of media content in response to the various inputs detected by the media processing device 110. For example, the VR application 112 may adapt presentation of visual content as the user moves his or her head to provide an immersive VR experience. An embodiment of a media processing device 110 is described in further detail below with respect to FIG. 2.

The client devices 140 comprises a computing device that executes a client application 142 providing a user interface to enable the user to input and view information that is directly or indirectly related to a VR experience. For example, the client application 142 may enable a user to set up a user profile that becomes paired with the VR application 112. Furthermore, the client application 142 may present various surveys to the user before and after VR experiences to gain information about the user's reaction to the VR experience. In an embodiment, the client device 140 may comprise, for example, a mobile device, tablet, laptop computer, desktop computer, gaming console, or other network-enabled computer device.

The media server 130 comprises one or more computing devices for delivering media content to the media processing devices 110 via the network 120 and for interacting with the client device 140. For example, the media server 130 may stream media content to the media processing devices 110 to enable the media processing devices 110 to present the media content in real-time or near real-time. Alternatively, the media server 130 may enable the media processing devices 110 to download media content to be stored on the media processing devices 110 and played back locally at a later time. The media server 130 may furthermore obtain user data about users using the media processing devices 110 and process the data to dynamically generate media content tailored to a particular user. Particularly, the media server 130 may generate media content (e.g., in the form of a VR experience) that is predicted to improve a particular user's mood based on profile information associated with the user received from the client application 142 and a machine-learned model that predicts how users' moods improve in response to different VR experiences.

The network 120 may include any combination of local area and/or wide area networks, using both wired and/or wireless communication systems. In one embodiment, the network 120 uses standard communications technologies and/or protocols. In some embodiments, all or some of the communication links of the network 120 may be encrypted using any suitable technique.

Various components of the media system 100 of FIG. 1 such as the media server 130, the media device 110, and the client device 140 can each include one or more processors and a non-transitory computer-readable storage medium storing instructions therein that when executed cause the one or more processors to carry out the functions attributed to the respective devices described herein.

FIG. 2 is a block diagram of a media processing device 110, according to one or more embodiments. In the illustrated embodiment, the media processing device 110 comprises a processor 250, a storage medium 260, input/output devices 270, and sensors 280. Alternative embodiments may include additional or different components.

The input/output devices 270 include various input and output devices for receiving inputs to the media processing device 110 and providing outputs from the media processing device 110. In an embodiment, the input/output devices 270 may include a display 272, an audio output device 274, a user input device 276, and a communication device 278. The display 272 comprises an electronic device for presenting images or video content such as an LED display panel, an LCD display panel, or other type of display. The display 272 may comprise a head-mounted display that presents immersive VR content. The audio output device 274 may include one or more integrated speakers or a port for connecting one or more external speakers to play audio associated with the presented media content. The user input device 276 can comprise any device for receiving user inputs such as a touchscreen interface, a game controller, a keyboard, a mouse, a joystick, a voice command controller, a gesture recognition controller, or other input device. The communication device 278 comprises an interface for receiving and transmitting wired or wireless communications with external devices (e.g., via the network 120 or via a direct connection). For example, the communication device 278 may comprise one or more wired ports such as a USB port, an HDMI port, an Ethernet port, etc. or one or more wireless ports for communicating according to a wireless protocol such as Bluetooth, Wireless USB, Near Field Communication (NFC), etc.

The sensors 280 capture various sensor data that can be provided as additional inputs to the media processing device 110. For example, the sensors 280 may include a microphone 282, an inertial measurement unit (IMU) 284, and one or more biometric sensors 286. The microphone 282 captures ambient audio by converting sound into an electrical signal that can be stored or processed by the media processing device 110. The IMU 284 comprises an electronic device for sensing movement and orientation. For example, the IMU 284 may comprise a gyroscope for sensing orientation or angular velocity and an accelerometer for sensing acceleration. The IMU 284 may furthermore process data obtained by direct sensing to convert the measurements into other useful data, such as computing a velocity or position from acceleration data. In an embodiment, the IMU 284 may be integrated with the media processing device 110. Alternatively, the IMU 284 may be communicatively coupled to the media processing device 110 but physically separate from it so that the IMU 284 could be mounted in a desired position on the user's body (e.g., on the head or wrist).

The biometric sensors 286 comprise one or more sensors for detecting various biometric signals of a user. Example biometric signals include heart rate, breathing rate, blood pressure, temperature, electrocardiogram (EKG), electroencephalogram (EEG), or other biometric data. The biometric sensors may be integrated into the media processing device 110, or alternatively, may comprise separate sensor devices that may be worn at an appropriate location on the human body. In this embodiment, the biometric sensors may communicate sensed data to the media processing device 110 via a wired or wireless interface.

The storage medium 260 (e.g., a non-transitory computer-readable storage medium) stores a VR application 112 comprising instructions executable by the processor 250 for carrying out functions attributed to the media processing device 110 described herein. In an embodiment, the VR application 112 includes a content presentation module 262 and an input processing module 264. The content presentation module 262 presents media content via the display 272 and the audio output device 274. The input processing module 264 processes inputs received via the user input device 276 or from the sensors 280 and provides processed input data that may control the output of the content presentation module 262 or may be provided to the media processing server 130. For example, the input processing module 264 may filter or aggregate sensor data from the sensors 280 prior to providing the sensor data to the media server 130.

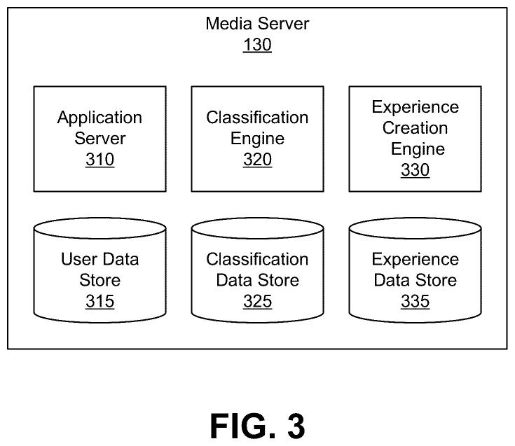

FIG. 3 is a block diagram of a media server 130, according to one or more embodiments. The media server 130 comprises an application server 310, a classification engine 320, an experience creation engine 330, a virtual agent engine 340, a user data store 315, a classification data store 325, an experience data store 335, and a virtual agent data store 345. In alternative embodiments, the media server 130 may comprise different or additional components. Various components of the media server 130 may be implemented as a processor and a non-transitory computer-readable storage medium storing instructions that when executed by the processor causes the processor to carry out the functions described herein.

The application server 310 obtains various data associated with users of the VR application 112 and the client application 142 during and in between VR experiences and indexes the data to the user data store 315. For example, the application server 310 may obtain profile data from a user during an initial user registration process (e.g., performed via the client application 142) and store the user profile data to the user data store 315 in association with the user. The user profile information may include, for example, a date of birth, gender, age, and location of the user. Once registered, the user may pair the client application 142 with the VR application 112 so that usage associated with the user can be tracked and stored in the user data store 315 together with the user profile information.

In one embodiment, the tracked data includes survey data from the client application 112 obtained from the user between VR experiences, biometric data from the user captured during (or within a short time window before or after) the user participating in a VR experience, and usage data from the VR application 112 representing usage metrics associated with the user. For example, in one embodiment, the application server 310 obtains self-reported survey data from the client application 142 provided by the user before and after a particular VR experience. The self-reported survey data may include a first self-reported mood score (e.g., a numerical score on a predefined scale) reported by the user before the VR experience and a second self-reported mood score reported by the user after the VR experience. The application server 310 may calculate a delta between the second self-reported mood score and the first self-reported mood score, and store the delta to the user data store 315 as a mood improvement score associated with the user and the particular VR experience. Additionally, the application server 310 may obtain self-reported mood tracker data reported by the user via the client application 142 at periodic intervals in between VR experiences. For example, the mood tracker data may be provided in response to a prompt for the user to enter a mood score or in response to a prompt for the user to select one or more moods from a list of predefined defined moods representing how the user is presently feeling. The application server 310 may furthermore obtain other text-based feedback from a user and perform a semantic analysis of the text-based feedback to predict one or more moods associated with the feedback.

The application server 310 may furthermore obtain biometric data from the media processing device 110 that is sensed during a particular VR experience. Additionally, the application server 310 may obtain usage data from the media processing device 110 associated with the user's overall usage (e.g., characteristics of VR experiences experienced by the user, a frequency of usage, time of usage, number of experiences viewed, etc.).

All of the data associated with the user may be stored to the user data store 315 and may be indexed to a particular user and to a particular VR experience.

In some embodiments, the application server 310 tracks user responses to personalized content presented during a virtual reality meditative experience. The application server 310 may receive set(s) of signal(s) indicating a state of the user during a virtual reality meditative experience. The signal(s) may include biometric data, e.g., captured by the biometric sensors 286. The signal(s) may also include user-provided input in response to prompts provided by the virtual reality application. Based on the received signal(s), the application server 310 may determine and track the user's mood over the course of the virtual reality meditative experience. The application server 310 may further track results of modifying the virtual agent and/or the experience in shifting the user's mood. For example, if the experience is targeting the user's mood to be relaxed, the application server 310 can determine, at varying intervals, whether the user's mood is relaxed or otherwise. If otherwise, the application server 310 may modify the virtual agent and/or the experience to induce a shift of the user's mood towards the relaxed mood.

The user data store 315 stores data related to the users and used by the media server 130. In some embodiments, the user data store 315 may be structured as a knowledge graph. As a knowledge graph, which relates various data points relating to the users in a graph form. The knowledge graph may comprise nodes, edges, and labels. Nodes may represent data points, e.g., users, digital content, characteristics of the content (e.g., acoustic characteristics of the virtual agent), user states (e.g., mental, emotive, etc.), other data analyzed by the media server 130. The edges connect nodes, with the labels annotating or providing additional detail around the edge connections. In other embodiments, the user data store 315 is structured as a relational database which stores the data in series of tables, each structured with rows and columns.

Based on the efficacy of certain modifications, the application server 310 may build a preference model to generalize the user's responses to the modifications. If the modifications successfully shift the user's mood to the target mood, the application server 310 may record a positive result. If the modifications are unsuccessful, the application server 310 may record a negative result. In some embodiments, the application server 310 may further subdivide the preference model based on different psychedelic compounds consumed. With the preference model, the application server 310 may personalize the virtual reality meditative experience to bias towards characteristics that induced positive results while biasing away from characteristics that induced negative results.

The classification engine 320 classifies data stored in the user data store 315 to generate aggregate data for a population of users. For example, the classification engine 320 may cluster users into user cohorts comprising groups of users having sufficiently similar user data in the user data store 315. When a user first registers with the media experience server 130, the classification engine 320 may initially classify the user into a particular cohort based on the user's provided profile information (e.g., age, gender, location, etc.). As the user participates in VR experiences, the user's survey data, biometric data, and usage data may furthermore be used to group users into cohorts. For example, based on the user's mood, the user's responses to personalized content, the user's response to particular psychedelic compounds, or some combination thereof, the classification engine 320 may reclassify users into different cohorts. Thus, the users in a particular cohort may change over time as the data associated with different users is updated. Likewise, the cohort associated with a particular user may shift over time as the user's data is updated. Based on the cohorts, the classification engine 320 may create baseline preference models, e.g., for a new user.

The classification engine 320 may furthermore aggregate data associated with a particular cohort to determine general trends in survey data, biometric data, and/or usage data for users within a particular cohort. Furthermore, the classification engine 320 may furthermore aggregate data indicating which digital assets were included in VR experiences experienced by users in a cohort. The classification engine 320 may index the aggregate data to the classification database 325. For example, the classification database 325 may index the aggregate data by gender, age, location, experience sequence, and assets. The aggregate data in the classification database 325 may indicate, for example, how mood scores changed before and after VR experiences including a particular digital asset. Furthermore, the aggregate data in the classification database 325 may indicate, for example, how certain patterns in biometric data correspond to surveyed results indicative of mood improvement.

The classification engine 320 may learn correlations between particular digital assets included in experiences viewed by users within a cohort and data indicative of mood improvement. The classification engine 320 may update the scores associated with the digital assets for a particular cohort based on the learned correlations.

The experience creation engine 330 generates the VR experience by selecting digital assets from the experience asset database 335 and presenting the digital assets according to a particular time sequence, placement, and presentation attributes. For example, the experience creation engine 330 may choose a background scene or template that may be colored according to a particular color palette. Over time during the VR experience, the experience creation engine 330 may cause one or more graphical objects to appear in the scene in accordance with selected attributes that control when the graphical objects appear, where the graphical objects are placed, the size of the graphical object, the shape of the graphical object, the color of the graphical object, how the graphical object moves throughout the scene, when the graphical object is removed from the scene, etc. Similarly, the experience creation engine 330 may select one or more audio objects to start or stop at various times during the VR experience. For example, a background music or soundscape may be selected and may be overlaid with various sounds effects or spoken word clips. In some embodiments, the timing of audio objects may be selected to correspond with presentation of certain visual objects. For example, metadata associated with a particular graphical object may link the object to a particular sound effect that the experience creation engine 330 plays in coordination with presenting the visual object. The experience creation engine 330 may furthermore control background graphical and/or audio objects to change during the course of a VR experience, or may cause a color palette to shift at different times in a VR experience.

The experience creation engine 330 may intelligently select the which assets to present during a VR experience, the timing of the presentation, and attributes associated with the presentation to tailor the VR experience to a particular user. For example, the experience creation engine 330 may identify a cohort associated with the particular user, and select specific digital assets for inclusion in the VR experience based on their scores for the cohort and/or other factors such as whether the asset is a generic asset or a user-defined asset. In an embodiment, the process for selecting the digital assets may include a randomization component. For example, the experience creation engine 330 may randomly select from digital assets that have at least a threshold score for the particular user's cohort. Alternatively, the experience creation engine 330 may perform a weighted random selection of digital assets where the likelihood of selecting a particular asset is weighted based on the score for the asset associated with the particular user's cohort, weighted based on whether or not the asset is user-defined (e.g., with a higher weight assigned to user-defined assets), weighted based on how recently the digital asset was presented (e.g., with higher weight to assets that have not recently been presented), or other factors. The timing and attributes associated with presentation of objects may be defined by metadata associated with the object, may be determined based on learned scores associated with different presentation attributes, may be randomized, or may be determined based on a combination of factors. By selecting digital assets based on their respective scores, the experience creation engine 330 may generate a VR experience predicted to a have a high likelihood to improve the user's moods.

In an embodiment, the experience creation engine 330 pre-renders the VR experience before being playback such that the digital objects for inclusion and their manner of presentation are pre-selected. Alternatively, the experience creation engine 330 may render the VR experience in substantially real-time by selecting objects during the VR experience for presentation at a future time point within the VR experience. In this embodiment, the experience creation engine 330 may adapt the VR experience in real-time based on biometric data obtained from the user in order to adapt the experience to the user's perceived change in mood. For example, the experience creation engine 330 may compute a mood score based on acquired biometric information during the VR experience and may select digital assets for inclusion in the VR experience based in part on the detected mood score.

In some embodiments, the experience creation engine 330 may further personalize the virtual reality meditative experience with a virtual agent. The virtual agent is a virtually-generated character that may interact with the user during the virtual reality meditative experience. The virtual agent effectively operates as a guide for the meditative experience. The virtual agent may include a visual appearance, a vocal track, or some combination thereof. The visual appearance of the virtual agent may be defined by a silhouette, a color, a size, a position, a brightness, any other visual characteristic, etc. The vocal track may be defined by a voice, speech presented, loudness, pitch, tonal personality, any other acoustic characteristic, etc. Tonal personality may indicate a manner of speaking, e.g., cheeky, sassy, endearing, calm, assertive, angry, sad, etc. The experience creation engine 330 may modify one or more characteristics of the virtual agent to personalize the virtual agent for the user. In some embodiments, the experience creation engine 330 may generate novel vocal tracks for the virtual agent, e.g., with a large language model, thereby enabling human-like conversations between the user and the virtual agent.

In some embodiments, the experience creation engine 330 utilizes a user preference model to modify the virtual agent and/or the virtual reality meditative experience to induce a mood shift in the user. The experience creation engine 330 may use the user preference model to inform what characteristics to modify and how to modify such characteristics. For example, the user preference model may comprise a color palette preference of the user, e.g., learned through prior responses by the user to personalization modifications of the virtual reality meditative experience. Accordingly, the experience creation engine 330 can modify the visual appearance of the virtual agent to accommodate the color palette preference of the user. In some embodiments, the experience creation engine 330 may apply a baseline user preference model for the initially-assigned cohort of a new user. In such embodiments, the application server 310 has yet to generate a user preference model for the new user. As such, the experience creation engine 330 may utilize a baseline user preference model (e.g., as an aggregate of other user preference models of users in the cohort) to personalize the VR experience for the new user. Based on the user's responses to the personalization modifications, the application server 310 may tailor the user preference model accordingly.

The experience data store 335 stores a plurality of digital assets that may be combined to create a VR experience. Digital assets may include, for example, graphical objects, audio objects, and color palettes. Each digital asset may furthermore be associated with asset metadata describing characteristics of the digital asset and stored in association with the digital asset. For example, a graphic object may have attribute metadata specifying a shape of the object, a size of the object, one or more colors associated with the object, etc.

Graphical objects may comprise, for example, a background scene or template (which may include still images and/or videos), and foreground objects (that may be still images, animated images, or videos). Foreground objects may move in three-dimensional space throughout the scene and may change in size, shape, color, or other attributes over time. Graphical objects may depict real objects or individuals, or may depict abstract creations.

Audio objects may comprise music, sound effects, spoken words, or other audio. Audio objects may include long audio clips (e.g., several minutes to hours) or very short audio segments (e.g., a few seconds or less). Audio objects may furthermore include multiple audio channels that create stereo effects.

Color palettes comprise a coordinated set of colors for coloring one or more graphical objects. A color palette may map a general color attributed to a graphical asset to specific RGB (or other color space) color values. By separating color palettes from color attributes associated with graphical objects, colors can be changed in a coordinated way during a VR experience independently of the depicted objects. For example, a graphical object (or particular pixels thereof) may be associated with the color “green”, gut the specific shade of green is controlled by the color palette, such that the object may appear differently as the color palette changes.

Digital assets may furthermore have one or more scores associated with them representative of a predicted association of the digital asset with an improvement in mood that will be experienced by a user having a particular user profile when the digital asset is included in a VR experience. In an embodiment, a digital asset may have a set of scores that are each associated with a different group of users (e.g., a “cohort”) that have similar profiles. Furthermore, the experience asset database 335 may track which digital assets were included in different VR experiences and to which users (or their respective cohorts) the digital assets were presented.

In an embodiment, the experience data store 335 may include user-defined digital assets that are provided by the user or obtained from profile data associated with the user. For example, the user-defined digital assets may include pictures of family members or pets, favorite places, favorite music, etc. The user-defined digital assets may be tagged in the experience data store 335as being user-defined and available only to the specific user that the asset is associated with. Other digital assets may be general digital assets that are available to a population of users and are not associated with any specific user.

The experience data store 335 may further include content for generating the virtual agent of the virtual reality experience. The content may include renderings of the virtual agent, e.g., for different users. For example, the virtual reality application may create personalized virtual agents (e.g., akin to an avatar) for users. Each personalized virtual agent may be stored in the experience data store 335. The content may also include vocal tracks for the virtual agent. The vocal tracks may be voice recordings, synthetically-generated vocal tracks, or some combination thereof. The voice recordings may include recordings in different voices, e.g., by different voice actors.

### Exemplary Methods

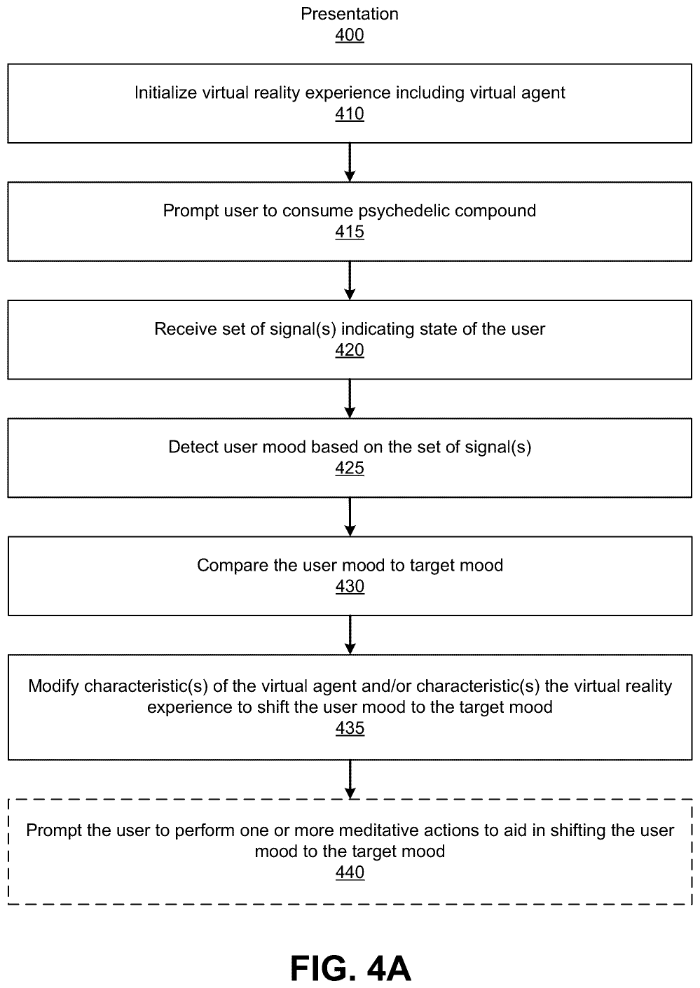

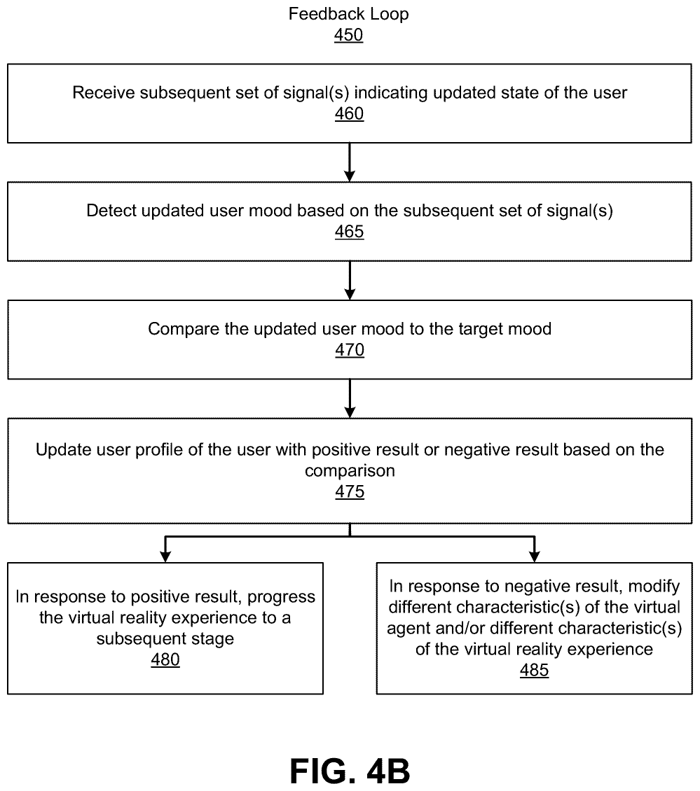

FIGS. 4A & 4B illustrate the process of providing a personalized virtual reality meditative experience including a virtual agent. The process utilizes the virtual agent to guide the meditative experience. The process involves implementing one or more personalization modifications to the virtual agent and/or the VR experience to induce mood shifts in the user. The mood of the user may be detected and sensed based on signals received indicating a state of the user (e.g., a physical state, a mental state, an emotional state, a medicated state, a spiritual state, etc.). The provision of the virtual reality meditative experience may be performed by the media system 100 of FIG. 1. In particular embodiments, the media server 130 may generate the personalized virtual reality meditative experience, and the media processing device 110, via the VR application 112, may present the personalized virtual reality meditative experience. In other embodiments, another device or set of devices may perform some or all of the steps described herein.

FIG. 4A illustrates a flowchart of presentation 400 of a personalized virtual reality meditative experience including a virtual agent, according to one or more embodiments.

The system initializes 410 a virtual reality meditative experience including a virtual agent. The system may present the virtual reality meditative experience via a virtual reality headset, e.g., including at least a display device and/or an audio device. The virtual agent is a virtual character in the VR experience that may interact with the user. For example, the virtual agent may provide guidance (e.g., in the form of movement and/or speech) to navigate the VR experience. The virtual agent may respond to inputs by the user. In some embodiments, the VR experience is initialized with one or more personalization modifications based on a user preference model for the user.

The system prompts 415 the user to consume a psychedelic compound. The system may prompt the user via the virtual agent. In other embodiments, the system may prompt the user with a text bubble, a speech command, another output manner, or some combination thereof. In some embodiments, the system may prompt a particular dosage of the psychedelic compound, e.g., 1X dose, 2X dose, 3X dose, 4X dose, 5X dose, etc. The psychedelic compound may be selected from: psilocybin, N,N-Dimethyltryptamine (DMT), mescaline, and lysergic acid diethylamide (LSD). The system may prompt a confirmation of the user upon completing consumption of the psychedelic compound.

The system receives 420 a set of signal(s) indicating a state of the user. The set of signals may include biometric signals (e.g., as measured by biometric sensors coupled to the virtual reality headset), user-provided inputs, or some combination thereof. The signals may indicate a physical state of the user (e.g., heart rate, etc.), a mental state of the user (e.g., EEG activity), an emotional state of the user (e.g., happy, sad, angry, anxious, stressed), a medicated state of the user (e.g., a degree of influence of the psychedelic compound), a spiritual state of the user, or some combination thereof.

The system detects 425 the user's mood based on the set of signals. The user mood may be one or more of a plurality of labels. For example, the labels may include (but are not limited to): relaxed, stressed, depressed, hopeful, angry, excited, romantic, other types of moods, etc. In some embodiments, the user mood may be categorized according to different hierarchies. For example, a first hierarchy utilizes a first set of general labels, and a second hierarchy subdivides one or more of the general labels into subcategories of the overarching mood. In some embodiments, the system may implement a machine-learning model to predict the user mood based on the set of signals. For example, the system may featurize the set of signals to generate a feature vector to input into the machine-learning model (e.g., a classifier) to predict the user mood.

The system compares the 430 the user mood to the target mood. During the VR meditative experience, the system may aim to achieve varying target moods throughout the VR experience. For example, in a first stage of the experience, the system may aim to achieve a first target mood, then, in a subsequent stage of the experience, may aim to achieve a second target mood. The system compares the user mood to the target mood to determine if the user mood matches to the target mood. If the user mood does not match, i.e., is sufficiently different than, the target mood, then the system may enact one or more modifications to induce a shift of the user mood toward the target mood.

The system modifies 435 one or more characteristic(s) of the virtual agent and/or one or more characteristic(s) of the VR experience to shift the user mood to the target mood. In such embodiments, the system determines that the user mood does not match the target mood, thereby enacts such modification(s) to induce a shift of the user's mood to the target mood. Modifications to the virtual agent may include modifications to visual characteristics and/or audio characteristics. Modifications to the VR experience may include modifying one or more characteristics of the virtual reality environment, digital assets presented in the experience, music or audio tracks, or some combination thereof. For example, the system may change the virtual reality environment (i.e., from a first environment to a second environment) to induce the mood shift.

In some embodiments, the system may prompt 440 the user to perform one or more meditative actions to aid in shifting the user mood to the target mood. The prompt may be directed through the virtual agent. Example meditative actions include, but are not limited to: breathing exercises, movement exercises, relaxation exercises, visualization exercises, mindfulness exercises, body and/or mental awareness exercises, muscle relaxation exercises, other exercises used in meditation, etc.

FIG. 4B illustrates a flowchart of a feedback loop 450 in the presentation of the personalized virtual reality meditative experience including the virtual agent, according to one or more embodiments. The feedback loop 450 serves to evaluate the efficacy of the personalization modifications in shifting the user's mood. The presentation 400 may occur in a first time period, and the feedback loop 450 may occur in a second time period after the first time period.

The system receives 460 a subsequent set of signal(s) indicating an updated state of the user. The subsequent set of signals may include biometric signals, user-provided input signals, or some combination thereof. Updated state may include a physical state, a mental state, an emotional state, a medicated state, a spiritual state, or some combination thereof.

The system detects 465 an updated user mood based on the subsequent set of signals. The updated user mood may be determined, e.g., with a machine-learning model. The updated mood may have shifted from the initial mood or may remain unchanged.

The system compares 470 the updated user mood to the target mood. The updated user mood may indicate efficacy in the personalization modification in shifting the user's mood. If the updated user mood now matches the target mood, then the personalization modifications were successful, indicating a positive result. If the updated user mood shifted towards the target mood, but not quite at the target mood, then the system may deem that a positive result, but perhaps a half-way positive result. If the updated user mood remain unchanged or diverged further from the target mood, then the system may deem that a negative result.

The system updates 475 the user profile with the positive result or the negative result based on the comparison. The system may update the user preference model with the results to further tune the user preference model. The tuned user preference model may be used by the system to tailor subsequent VR experiences.

The system, in response to a positive result, may progress 480 the virtual reality meditative experience to a subsequent stage. In such embodiments, the VR experience progresses between stages when the target mood for each stage is met. The next stage may include a different set of virtual reality environment, different digital assets, different content presented by the virtual agent, or some combination thereof.

The system, in response to a negative result, may modify 485 different characteristic(s) of the virtual agent and/or different characteristic(s) of the VR experience. For example, if a first set of modifications failed to shift the user's mood towards the target mood, then the system can try a second set of different modifications. For example, a first color palette of the virtual agent and/or the virtual environment was unsuccessful, so a different color palette is used.

The system may iteratively implement the feedback loops throughout the VR experience, to induce shifts in the user mood. The system may, as with the presentation 400 flowchart, prompt the user to perform one or more meditative actions in conjunction with personalization modifications to induce the mood shift.

### Example Virtual Reality Meditative Experience

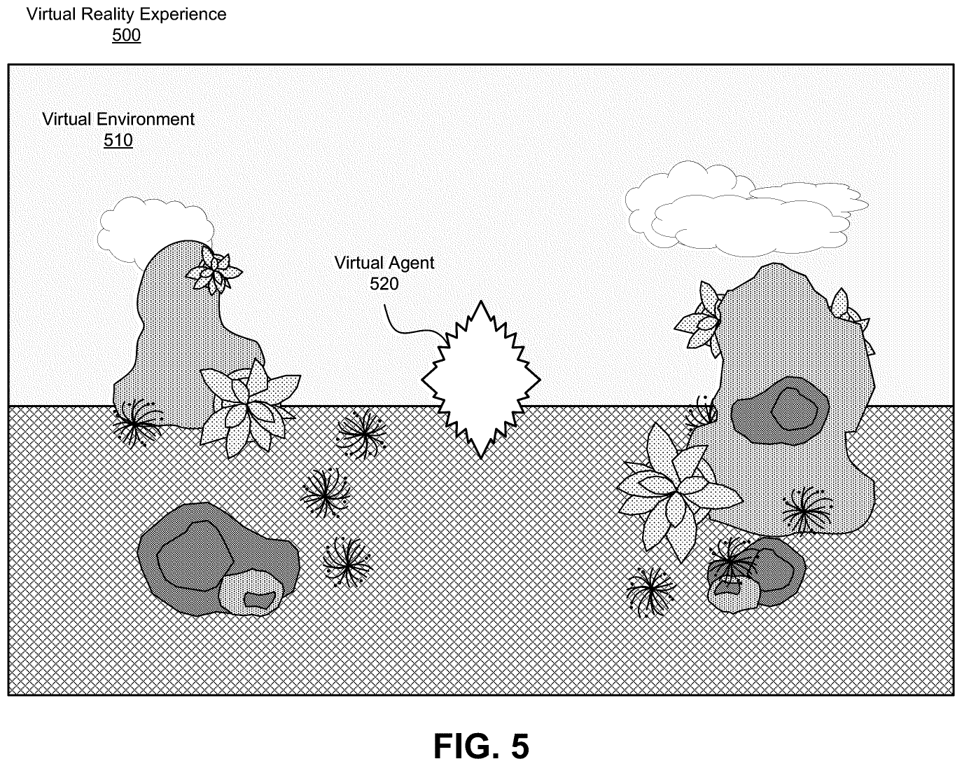

FIG. 5 illustrates an example virtual reality experience 500 including a virtual agent 520, according to one or more example implementations. The VR experience 500 includes visual content presented to the user, e.g., via a display device on a VR headset. The visual content may include presenting a virtual environment 510 with one or more virtual elements (e.g., digital assets). The virtual agent 520 may have a visual appearance and may include a vocal track. The virtual agent 520 interacts with the user, providing guidance through the VR experience 500. During the VR experience 500, the system may modify characteristics of the virtual agent 520 to induce a shift of the user's mood. For example, the system may change a silhouette of the virtual agent 520, a size of the virtual agent 520, a color of the virtual agent 520, a position of the virtual agent 520, a translucence of the virtual agent 520, a brightness of the virtual agent 520, etc. The system may also change acoustic characteristics of the virtual agent 520, by changing the vocal track, the loudness, the pitch, the voice, etc.

### Additional Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements that are not in direct contact with each other, but yet still co-operate or interact with each other.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for the described embodiments as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

1. A computer-implemented method comprising:
initializing a virtual reality experience by presenting, via a virtual agent, vocal track comprising speech by the virtual agent;
prompting, via the vocal track by the virtual agent, a user to consume a psychedelic compound;
in a first stage of the virtual reality experience:
receiving a first set of signals indicating a state of the user, wherein the first set of signals include speech input by the user interacting with the virtual agent;
detecting a user mood based on the first set of signals;
determining that the user mood is different than a first target mood for the first stage of the virtual reality experience;
modifying one or more characteristics of the vocal track of the virtual agent to shift the user mood to the first target mood;
generating a novel vocal track for the virtual agent based on the speech input by the user by applying a large language model to the speech input;
presenting the novel vocal track with the modified one or more characteristics;
receiving a second set of signals indicating an updated state of the user upon presentation of the novel vocal track with the modified one or more characteristics;
detecting an updated user mood based on the second set of signals;
determining that the updated user mood matches the first target mood; and
transitioning the virtual reality experience into a second stage with a second target mood.

2. The computer-implemented method of claim 1, wherein prompting the user further comprises prompting with a text prompt on a display of a virtual reality headset.

3. (canceled)

4. The computer-implemented method of claim 1, wherein the virtual reality experience includes one or more virtual reality environments.

5. The computer-implemented method of claim 4, further comprising:
progressing the virtual reality experience to shift from a first virtual reality environment to a second virtual reality environment to shift the user mood to the first target mood.

6. The computer-implemented method of claim 4, further comprising, in the first stage of the virtual reality experience:
receiving a second set of signals indicating a second state of the user;
detecting a second user mood based on the second set of signals;
determining that the second user mood matches the first target mood; and
progressing the virtual reality experience from a first virtual reality environment to a second virtual reality environment.

7. The computer-implemented method of claim 1, wherein the first set of signals comprises one or more biometric signals detected from one or more sensors coupled to a virtual reality headset.

8. The computer-implemented method of claim 1, wherein the first set of signals comprises one or more user inputs indicating an emotional state of the user.

9. The computer-implemented method of claim 1, wherein detecting the user mood comprises applying a machine-learning model to the first set of signals to predict the user mood.

10. The computer-implemented method of claim 1, further comprising, in the first stage of the virtual reality experience:
modifying one or more characteristics of the virtual agent to shift the user mood to the target mood;
wherein characteristics of the virtual agent include a combination of:
a visual appearance of the virtual agent;
a size of the virtual agent;
a color of the virtual agent;
a position of the virtual agent;
a vocal track of the virtual agent;
a loudness of the vocal track of the virtual agent;
a pitch of the vocal track of the virtual agent; and
a tonal personality of the vocal track of the virtual agent.

11. The computer-implemented method of claim 1, further comprising, in the first stage of the virtual reality experience:
receiving a second set of signals indicating a second state of the user;
detecting a second user mood based on the second set of signals;
determining that the second user mood is different than the first target mood; and
modifying one or more other characteristics of the virtual agent to shift the second user mood to the first target mood.

12. The computer-implemented method of claim 11, further comprising:
updating a user profile of the user to include a negative result of modifying the one or more characteristics of the virtual agent.

13. The computer-implemented method of claim 1, further comprising, in the first stage of the virtual reality experience:
receiving a second set of signals indicating a second state of the user;
detecting a second user mood based on the second set of signals;
determining that the second user mood matches the first target mood; and
updating a user profile of the user to include a positive result of modifying the one or more characteristics of the virtual agent.

14. The computer-implemented method of claim 1, further comprising, in the first stage of the virtual reality experience:
prompting the user to perform one or more meditative actions during the first stage of the virtual reality experience.

15. A non-transitory computer-readable storage medium storing instructions that, when executed by a processor, cause the processor to perform operations comprising:
initializing a virtual reality experience by presenting, via a virtual agent, a vocal track comprising speech by the virtual agent;
prompting, via the vocal track by the virtual agent, a user to consume a psychedelic compound;
in a first stage of the virtual reality experience:
receiving a first set of signals indicating a state of the user, wherein the first set of signals include speech input by the user interacting with the virtual agent;
detecting a user mood based on the first set of signals;
determining that the user mood is different than a first target mood for the first stage of the virtual reality experience;
modifying one or more characteristics of the vocal track of the virtual agent to shift the user mood to the first target mood;
generating a novel vocal track for the virtual agent based on the speech input by the user by applying a large language model to the speech input;
presenting the novel vocal track with the modified one or more characteristics;
receiving a second set of signals indicating an updated state of the user upon presentation of the novel vocal track with the modified one or more characteristics;
detecting an updated user mood based on the second set of signals;
determining that the updated user mood matches the first target mood; and
transitioning the virtual reality experience into a second stage with a second target mood.

16. The non-transitory computer-readable storage medium of claim 15, wherein prompting the user further comprises:
prompting with a text prompt on a display of a virtual reality headset.

17. The non-transitory computer-readable storage medium of claim 15, wherein the first set of signals comprises:
one or more biometric signals detected from one or more sensors coupled to a virtual reality headset; or
one or more user inputs indicating an emotional state of the user.

18. The non-transitory computer-readable storage medium of claim 15, wherein detecting the user mood comprises applying a machine-learning model to the first set of signals to predict the user mood.

19. The non-transitory computer-readable storage medium of claim 15, the operations further comprising, in the first stage of the virtual reality experience:
receiving a second set of signals indicating a second state of the user;
detecting a second user mood based on the second set of signals;
determining that the second user mood is different than the first target mood; and
modifying one or more other characteristics of the virtual agent to shift the second user mood to the first target mood.

20. The non-transitory computer-readable storage medium of claim 15, the operations further comprising, in the first stage of the virtual reality experience:
receiving a second set of signals indicating a second state of the user;
detecting a second user mood based on the second set of signals;
determining that the second user mood matches the first target mood; and
updating a user profile of the user to include a positive result of modifying the one or more characteristics of the virtual agent.
